(19) United States
(12) Patent Application Publication
(10) Pub. No.: US 2005/0161145 A1
(43) Pub. Date: Jul. 28, 2005

(54) Apparatus and method for camouflaging outdoor accessories using thermoplastic shrink-wrap

(76) Inventor: William Record, Sullivan, MO (US)

Correspondence Address: THOMPSON COBURN, LLP, ONE US BANK PLAZA, SUITE 3500, ST LOUIS, MO, 63101, US

(21) Appl. No.: 11/084,615

(22) Filed: Mar. 18, 2005

Related U.S. Application Data
(62) Division of application No. 10/732,691, filed on Dec. 10, 2003, now abandoned.
Application No. 10/732,691 is a division of application No. 09/577,998, filed on May 24, 2000, now abandoned.
(60) Provisional application No. 60/140,078, filed on Jun. 21, 1999.

(51) Int. Cl. B32B 31/00

(52) U.S. Cl. 156/84

(57) ABSTRACT

A method and apparatus for camouflaging hunting equipment utilizes one or more pieces of thermoplastic shrink-wrap provided with a camouflage pattern. Each piece of shrink-wrap is positioned around a portion of an item to be camouflaged and is then heat-shrunk to constrict the piece of shrink-wrap around the portion of the item. Once shrunken by applying heat, excess portions of the shrink-wrap can be easily trimmed away, thereby provided a professional-looking camouflage finish. When desired, the camouflage shrink-wrap can easily be removed from the item by tearing a portion of the shrink-wrap and peeling the rest away without damaging the item's original finish.

This application is a divisional of the pending application Ser. No. 10/732,691 filed on Dec. 10, 2003, which claims priority to U.S. application Ser. No. 09/577,998 filed on May 24, 2000, which claimed priority to U.S. Provisional Application No. 60/140,078 filed Jun. 21, 1999.

### BACKGROUND OF THE INVENTION

(1) Field of the Invention

This invention pertains to the field of providing camouflage to hunting or other accessories. More particularly, this invention pertains to a piece of thermoplastic shrink-wrap having a camouflage finish and to a method of using thermoplastic shrink-wrap to camouflage various items of hunting equipment. Use of the invention allows camouflage patterns to be quickly and easily applied to items without damaging, deforming, or obstructing the use of the item. When desired, the camouflage can be quickly removed from the item by tearing the thermoplastic shrink-wrap from the item's surface without any residue remaining after removal of the shrink-wrap.

(2) Description of the Related Art

It is known that various items of equipment used by hunters, nature watchers, or photographers can be easily spotted by most wildlife, unless such items are camouflaged. This is especially true of animals having keen eyesight, such as birds. As a result, it has become advantageous to use camouflage on various hunting or other outdoor equipment such as firearms, wildlife-calls, and drinking mugs in an effort to avoid being detected by wildlife. In response to the demand for items that are camouflaged and the wide variety of hunting and other equipment sought to be camouflaged, numerous devices and methods have been developed for camouflaging such items.

One method used to camouflage such items comprises the use of a camouflage tape having a camouflage pattern printed thereon and an adhesive to secure the tape to the item. Typically such camouflage tape is made of fabric or plastic and is applied to an item by wrapping the tape around the item being camouflaged such that the adhesive secures the tape to the item. This method of camouflaging items, although versatile in that the camouflage tape can be wrapped around items having various shapes and dimensions, nonetheless has several disadvantages. For example, camouflage tape is often difficult to apply in a smooth and even fashion and is both time consuming to apply as well as to remove. Furthermore, removal of the camouflage tape often leaves a sticky residue on the item. This is especially true when the tape is left on the item for prolonged periods of time. Moreover, if the item gets wet, as often happens when spending time outdoors in the rain or around water, the tape easily retains moisture and can cause serious corrosion of metallic items. As a result of these disadvantages, many hunters avoid using camouflage tape.

Another method used for camouflaging hunting items comprises the use of camouflage spray paints. Such camouflage spray paints are specially adapted to produce a finish having an uneven pattern of various colors. Although camouflage spray paint can be used on virtually all items, use of this method also presents several disadvantages. Perhaps the most significant disadvantage is that once applied, spray paint can not easily be removed from an item and in many cases can not be removed without damaging the original finish of the item. Additionally, the camouflage spray paint is messy, difficult to apply, and does not produce distinct camouflage patterns.

Yet another prior art method used for camouflaging items, similar to the camouflage spray paint method described above, comprises the use of a camouflage spray-on and pull-off rubbery composite coating. Unlike the camouflage spray paint method, this type of camouflage is removable from the items once applied. However, like camouflage spray paint, this method is messy to use, difficult to apply, and does not produce a specific camouflage pattern.

A more precise method of applying a specific camouflage finish on items comprises an electrostatic process. This method produces a high quality camouflage finish, but can only be used on metallic items such as firearms. Furthermore, this method is expensive, permanent, and can not be performed by consumers. Several other types of “factory finishes” exist and all suffer from the same disadvantages.

Finally, a non-permanent means of quickly camouflaging items comprises the use of slip-on camouflaged textile materials such as rifle socks or hosiery. An advantage of using this type of camouflaging method is that the camouflage can quickly be removed from and replaced on a particular item. However, these devices are bulky and absorb water. Additionally, the slip-on devices often become unraveled and can easily be snagged on nearby vegetation when hunting. Furthermore, when using slip-on devices to camouflage firearms in particular, the slip-on device can reduce a person's grip and interfere with the proper operation of the firearm, thereby creating a safety hazard.

The present invention overcomes the disadvantages associate with prior art devices and methods used to camouflage hunting equipment by providing a camouflage pattern on a piece of thermoplastic shrink-wrap that can easily be heat-shrunk onto various different items and objects. Using the invention, various hunting items can be quickly and inexpensively camouflaged with a predetermined camouflage pattern. The shrink-wrap of the present invention, although durable and long lasting, can be easily removed without leaving residue on or otherwise damaging the items being covered. The ease of application and the low costs associated with use of shrink-wrap allows hunters to change the camouflage pattern of their equipment to match their surroundings using specific patterns adapted for use in various surroundings such as grass fields, woods, snow, and brush.

### SUMMARY OF THE INVENTION

The present invention is directed to the camouflaging of various outdoor items and accessories of various shapes, sizes, and materials. The present invention can be used for hunting items, outdoor photography items, bird watching items, or other items used by persons who spend time outdoors and want to conceal themselves from animals, including fish and birds. In accordance with the invention, a piece of camouflaged shrink-wrap is provided which can be heat-shrunk onto a given item to provide a particular camouflage pattern thereon. When desired, the camouflage finish can be removed by simply peeling the shrink-wrap from the item.

In general, the camouflage shrink-wrap of the preferred embodiment comprises a sheet of thermoplastic material having a camouflage pattern printed thereon. The sheet of shrink-wrap is configured to be wrapped around an object in a manner where, preferably, one portion of the shrink-wrap can be adhered to another portion of the shrink-wrap to secure the shrink-wrap on the item. Alternatively, the opposite edges of the sheet of shrink-wrap can be adhered directly to the object to be camouflaged, without completely encircling the object.

A further embodiment of the present invention comprises a tubular portion of thermoplastic material having a camouflage pattern printed thereon. The tubular shrink-wrap is configured to be slipped over an axial end of the object being camouflaged, where it can then be heat-shrunk around the exterior of the object.

In another aspect of the invention, a method is disclosed for applying a piece of either sheet or tubular camouflage shrink-wrap on various items. In general, the method comprise providing a piece of thermoplastic shrink-wrap and applying a camouflage pattern thereto, positioning the piece of shrink-wrap relative to the item being camouflaged, and applying heat to the piece of shrink-wrap to cause the piece of shrink-wrap to constrict against a portion of the item.

In addition to the use of the shrink-wrap as camouflage, the shrink-wrap also serves to protect items from the elements and from being scratched. Yet another function served by the shrink-wrap lies in the ability of the shrink-wrap to hold components of an item together that could otherwise easily be separated. As an example, the barrel and stopper of typical wildlife-calls are often easily separated. By applying camouflage shrink-wrap around such wildlife-calls, the components are secured together, thereby eliminating the need for a double lanyard between the components.

While the principle advantages and features of the present invention have been described above, a more complete and thorough understanding and appreciation of the invention may be obtained by referring to the drawings and the detailed description of the preferred embodiments, which follow.

### BRIEF DESCRIPTION OF THE DRAWINGS

FIG. 1 is an isometric view of the camouflage shrink-wrap of the preferred embodiment formed as a sheet of shrink-wrap.

FIG. 2 is an isometric view of the camouflage shrink-wrap of an alternative embodiment formed as a tube of shrink-wrap.

FIG. 3 is an isometric view of the camouflage shrink-wrap of the preferred embodiment of the invention being applied to portions of a shotgun.

FIG. 4 is an isometric view of the camouflage shrink-wrap of FIG. 3 shown after heat has been used to constrict the shrink-wrap against the surface of the shotgun.

FIG. 5 is an isometric view similar to FIG. 4 showing the completed product after portions of the shrink-wrap have been trimmed away.

FIG. 6 is an isometric view of the camouflaged shrink-wrap of the preferred embodiment being applied partially around the forearm of a pump-action shotgun.

FIG. 7 is an isometric view of an alternative tubular form of the shrink-wrap of the invention shown being applied to a forearm of a shotgun.

Reference characters in the written specification indicate corresponding parts throughout the several views of the drawings.

### DETAILED DESCRIPTION OF THE INVENTION

The preferred embodiment of the camouflage shrink-wrap is formed of any type of commercially available thermoplastic material commonly used as shrink-wrap. The preferred embodiment has a camouflage pattern printed on at least one of its opposite surfaces. To reduce glare caused by reflection, the camouflage pattern preferably has a matted finish. However, the specific camouflage pattern that is printed on the shrink-wrap is not pertinent to the invention, and it should be understood that various camouflage patterns known in the art could be utilized interchangeably with the invention. Examples of such patterns include solid white for camouflage in snow conditions and well known patterns such as REALTREE™, ADVANTAGE™, and MOSSY OAK™.

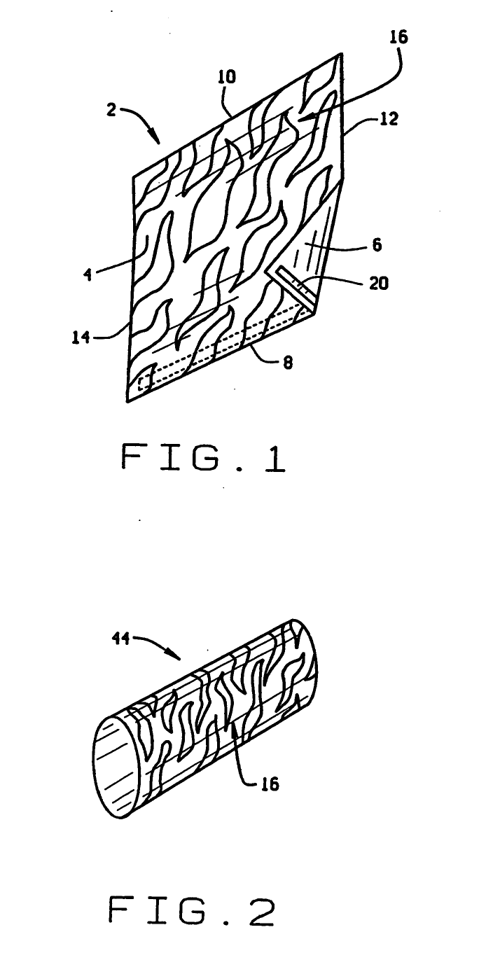

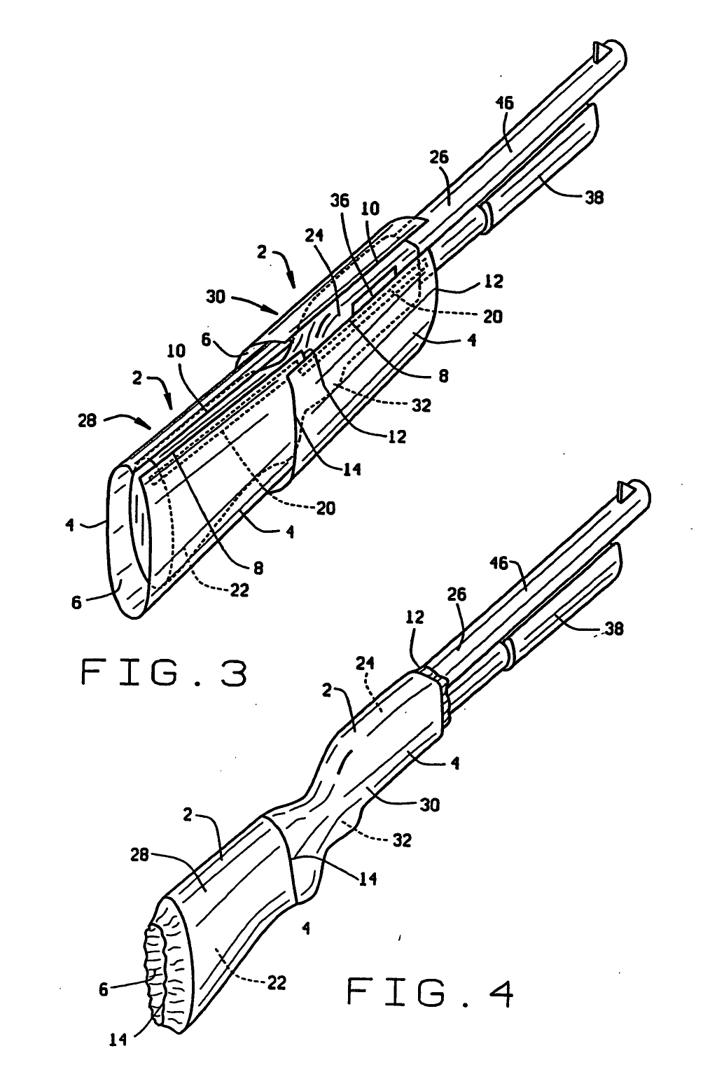

As shown in FIG. 1, the camouflage shrink-wrap 2 of the invention is preferably a rectangular sheet of thermoplastic material having opposite first 4 and second 6 surfaces. The area of the sheet is defined by opposite first 8 and second 10 longitudinal edges of the sheet and opposite first 12 and second 14 lateral edges of the sheet. The sheet can be manufactured in various sizes for various applications, or smaller sheets can be cut from larger sheets as needed. Additionally, in the preferred embodiment, the shrink-wrap 2 has a camouflage pattern 16 printed on only one of its opposite surfaces. In the illustrated embodiment, the camouflage pattern 16 is printed on the first surface 4 of shrink-wrap 2 which will become the exterior, visible surface when used, (the camouflage pattern is omitted from FIGS. 3-7 for clarity). The sheet is also preferably manufactured with a double-sided, pressure sensitive adhesive strip 20 positioned on the second surface 6 adjacent the first longitudinal edge 8 of the sheet. The adhesive strip 20 preferably has a removable backing sheet (not shown) that covers the adhesive strip 20 until proper positioning of the shrink-wrap 2 is achieved as described below, at which time it can then be peeled away to expose the adhesive backing strip.

FIG. 3 shows the shrink-wrap being applied to a stock 22 and receiver 24 of a pump-action shotgun 26 for purposes of describing the apparatus and method of the invention. The shrink-wrap 2 is preferably wrapped around the item with its first, camouflaged surface 4 visible. When applying the shrink-wrap 2 completely around an item such as the stock 22 of the shotgun 26, the first longitudinal edge 8 of the shrink-wrap is brought over the opposite, second longitudinal edge 10 and portions adjacent the longitudinal edges are overlapped until the shrink-wrap is generally taut around the item. On items having a non-constant circumference such as the stock 22 of the shotgun 26, the shrink-wrap 2 can be wrapped in a frustoconical manner and a portion of the sheet adjacent the second edge 6 can be trimmed at an angle to remove excess overlapping material, thereby reducing the amount of shrinkage necessary and minimizing the distortion of the camouflage pattern when shrunk. It is preferable to position the shrink-wrap 2 with at least one of the lateral edges 12, 14 extended beyond the end of the item to account for longitudinal shrinkage of the shrink-wrap. Once in position, the backing sheet is removed from the adhesive strip 20 and the overlapping portions of the shrink-wrap 2 are pressed against each other to secure the portions together using the adhesive strip 20.

The shrinkage process is performed using heat supplied from a separate device such as a conventional hair blow-dryer. Preferably, heat is applied initially near the center of the shrink-wrap 2 and gradually moved outwardly toward the opposite lateral edges 12, 14 of the shrink-wrap. The shrink-wrap 2 preferably has properties which allow the shrink-wrap to contract a minimum of fifty-percent in the lateral direction while only contracting a maximum of ten-percent in the longitudinal direction. These properties allow the shrink-wrap 2 to constrict to the exterior surface of the item being camouflaged without causing excessive longitudinal shrinkage which could complicate the camouflaging procedure or cause undesirable deformation of copyrighted patterns. Once the shrink-wrap 2 has constricted to the surface of the item being camouflaged, frictional forces and contours of the item's surface prevent the shrink-wrap from sliding off or rotating about the item.

After any given shrink-wrap 2 has been applied and shrunken, one or more additional pieces of shrink-wrap 2 can be utilized in a similar manner to completely cover the item if necessary. FIGS. 3-5 show a first shrink-wrap sheet 28 being used to cover the stock 22 of the shotgun 26 and a second shrink-wrap sheet 30 being used to cover the receiver 24. When utilizing more than one shrink-wrap sheet 2 to camouflage an item, it is preferable to overlap the lateral edges 12, 14 of adjacent pieces of shrink-wrap by a few inches to prevent any gaps from being formed therebetween due to longitudinal contraction of the sheets as they are shrunk.

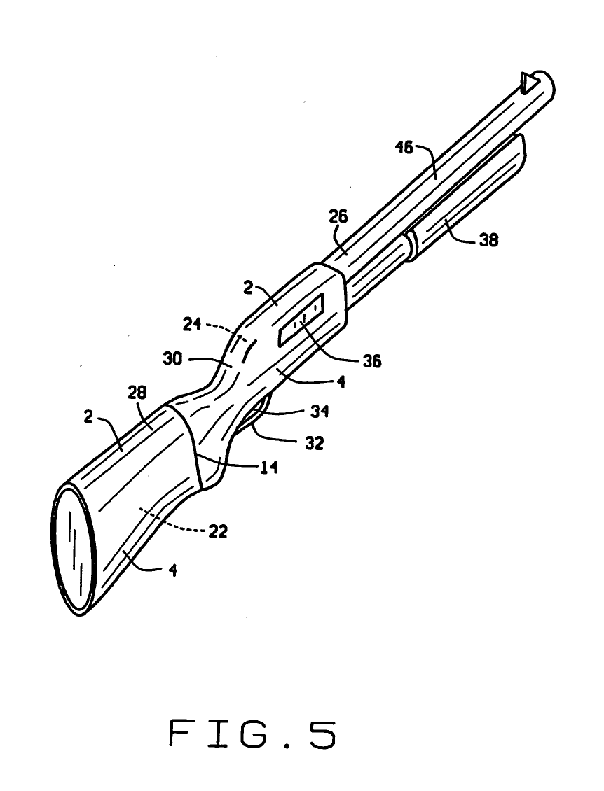

During the process of heat shrinking, it may become necessary to trim away portions of the thermoplastic material using a knife or other suitable tool to prevent the shrink-wrap 2 from obstructing specific portions of the item being camouflaged. During the camouflaging of the shotgun 26 as described above, for example, the second shrink-wrap sheet 30 is initially shrunken around the trigger mechanism 32 as shown in FIG. 4. However, after the shrink-wrap sheet 30 has been substantially shrunken and allowed to cool, an opening 34 in the shrink-wrap 30 can be made for the trigger mechanism 32 and heat can be reapplied to the shrink-wrap to further contract the portion of the shrink-wrap around the opening 34 to allow the trigger mechanism 32 to extend therethrough as shown in FIG. 5. Additionally, any excess thermoplastic material that extends beyond the desired area to be camouflaged such as one or more of the lateral edges 12, 14, can easily be trimmed away after the shrink-wrap has cooled. Similarly, thermoplastic material covering components such as the shotgun ejection port 36 shown in FIG. 5 can also be removed as needed to prevent the shrink-wrap 2 from interfering with the operation of item being camouflaged.

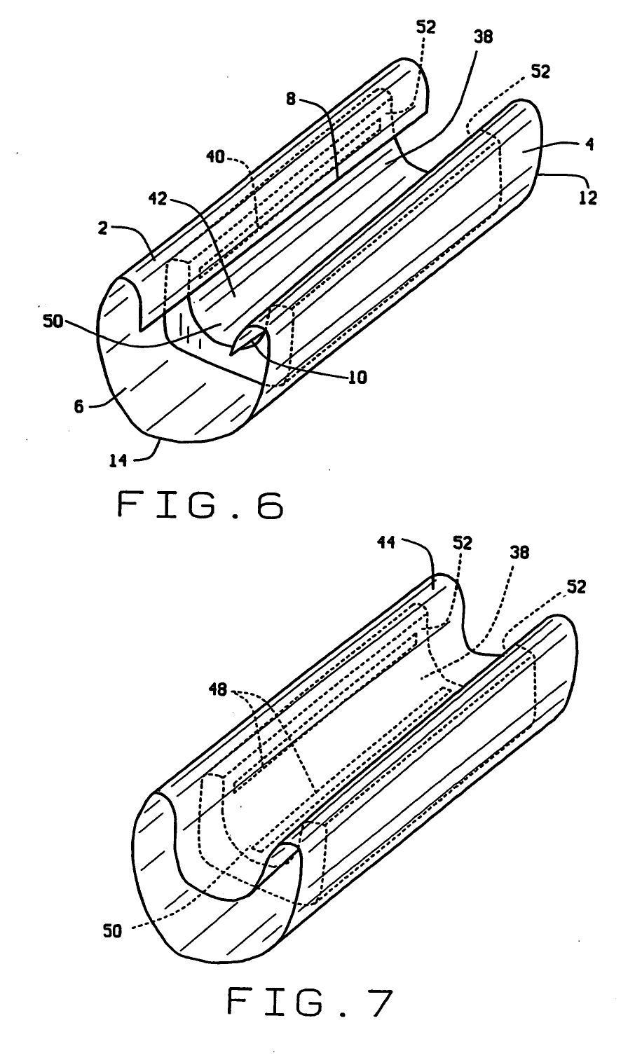

Rather than wrapping a sheet of shrink-wrap in an overlapping manner around an item being camouflaged and then adhering the shrink-wrap to itself as described above, the shrink-wrap can be adhered directly to the item being camouflaged. This is especially practical when covering the entire circumference of the item is not necessary. As shown in FIG. 6, for example, the shrink-wrap 2 can be partially wrapped around the forearm 38 of the shotgun 26 using an adhesive 40 or other suitable means to hold the opposite first 8 and second 10 longitudinal edges of the shrink-wrap in the channel 42 of the forearm.

In addition to the preferred embodiment of the shrink-wrap sheet 2 described above, a piece of shrink-wrap 44 in the form of a tube, as shown in FIG. 7, can be utilized to camouflage various items as well. The piece of tubular shrink-wrap 44 can be slipped longitudinally over items such as the barrel 46 of the shotgun 26 and then heat shrunk and trimmed in the manner described above. Using a piece of tubular shrink-wrap 44 eliminates the need to use adhesives and various pieces of tubular shrink-wrap of differing circumferential dimensions can be formed to accommodate various shapes and sizes of items being camouflaged.

When using pieces of shrink-wrap 2,44 either in sheet or tubular form, adhesives can be used to hold the piece of shrink-wrap against concave or recessed surface portions of an item being camouflaged. As an example, the piece of tubular shrink-wrap 44 shown in FIG. 7 is adhered to the channel 42 of the forearm 38 using strips of double-sided tape 48 positioned at the center of the channel 50 and along the opposite side walls 52 of the channel. The double-sided tape 48 prevents the shrink-wrap 44 from bridging across the channel 42 of the shotgun forearm 38 as the shrink-wrap is being shrunk. Although the particular adhesive used is not pertinent to the invention and various types of tape or glue could be used, a removable double-sided adhesive strip is preferably used to facilitate the removal of the shrink-wrap 2,44 and the adhesive from the camouflaged item when desired.

With the installation complete, the item has a easily grasped camouflage finish that lies tight against the exterior surface of the item and that will not move or shift. Additionally, the thermoplastic material used by the invention is preferably impervious to petroleum based oils commonly used to lubricate firearms and will not deteriorate when exposed to such oils. Furthermore, the thermoplastic material remains flexible after being applied to an item, thereby preventing any flexible portions of an item, such as the flexible portion of common wildlife-calls, from becoming inoperable.

Although the invention has been described above by reference to specific embodiments, it should be understood that the invention is not limited to these embodiments and numerous alternative embodiments or changes to these embodiments could be made without departing from the scope of the invention. For example, although the preferred embodiment of a piece of shrink-wrap is described as having an adhesive strip along one of its longitudinal edges, such an adhesive need not be present. In a situation where the shrink-wrap is provided with a different camouflage pattern on opposite sides, use of tape would be preferred over an adhesive strip because the orientation of the adhesive strip would not be predeterminable. Additionally, any means such as using glues, or any other means known in the art of attaching the shrink-wrap to an item could be used. Furthermore, various different material properties of the thermoplastic material and various different shapes and configurations of shrink-wrap could be used in various applications. For example, a triangular sheet of shrink-wrap could be used to camouflage a cone shaped item.

Thus it should be clear that modifications and variations of the invention could be made without departing from the scope of the invention which should be considered as being limited only by the scope of the claims and their equivalents.

1-20. (canceled)

21. A method of camouflaging an item, the method comprising:
providing a piece of thermoplastic shrink-wrap, the piece of shrink-wrap comprising a sheet of thermoplastic material having opposite first and second surfaces and at least two edge portions, the first and second surfaces each extending in opposite longitudinal and lateral directions, the piece of shrink-wrap being configured and adapted to contract disproportionally in the opposite longitudinal and lateral directions, the piece of shrink-wrap also comprising a camouflage pattern on the first surface of the sheet of thermoplastic material;
positioning the piece of shrink-wrap adjacent a portion of the item to be camouflaged by adhering the at least two edge portions of the piece of shrink-wrap together in an overlapping manner and such that the piece of shrink-wrap encircles at least a portion of the item with the camouflage pattern on the first surface facing away from the portion of the item; and
applying heat to the piece of shrink-wrap causing the piece of shrink-wrap to constrict over the portion of the item.

22. A method in accordance with claim 21 wherein the step of providing the piece of thermoplastic shrink-wrap occurs in a manner such that the piece of shrink-wrap is configured and adapted to contract less in the longitudinal direction than in the lateral direction and each of the two edge portions extend in at least the longitudinal direction.

23. A method in accordance with claim 21 wherein the step of providing the piece of thermoplastic shrink-wrap occurs in a manner such that the first and second surfaces of the piece of shrink-wrap are rectangular in shape, the piece of shrink-wrap is configured and adapted to contract less in the longitudinal direction than in the lateral direction, and each of the two edge portions are aligned with the longitudinal direction.

24. A method in accordance with claim 21 further comprising a step of:
allowing the piece of shrink-wrap to cool after the step of applying heat to the piece of shrink-wrap causing the shrink-wrap to constrict and further comprising the step of trimming undesired portions of the piece of shrink-wrap from the item after the step of allowing the piece of shrink-wrap to cool.

25. A method in accordance with claim 21 wherein the item to be camouflaged is a firearm.

26. A method of camouflaging an item, the method comprising:
providing a piece of thermoplastic shrink-wrap, the piece of shrink-wrap comprising a sheet of thermoplastic material having opposite first and second surfaces and at least two edge portions, the first and second surfaces each extending in opposite longitudinal and lateral directions, each of the two edge portions extending in at least the longitudinal direction, the piece of shrink-wrap being configured and adapted to contract less in the longitudinal direction than in the lateral direction, the piece of shrink-wrap also comprising a camouflage pattern on the first surface of the sheet of thermoplastic material;
positioning the piece of shrink-wrap adjacent a portion of the item to be camouflaged by attaching each of the at least two edge portions of the piece of shrink-wrap to the portion of the item in a manner such that the camouflage pattern on the first surface faces away from the portion of the item; and
applying heat to the piece of shrink-wrap causing the piece of shrink-wrap to constrict over the portion of the item.

27. A method in accordance with claim 26 wherein the step of providing the piece of thermoplastic shrink-wrap occurs in a manner such that the first and second surfaces of the piece of shrink-wrap are rectangular in shape and each of the two edge portions are aligned with the longitudinal direction.

28. A method in accordance with claim 26 wherein the step of positioning the piece of shrink-wrap adjacent the portion of the item to be camouflaged by attaching each of the at least two edge portions of the piece of shrink-wrap to the portion of the item occurs at least partially be adhering each of the at least two edge portions of the piece of shrink-wrap to the portion of the item.

29. A method in accordance with claim 26 further comprising a step of:
allowing the piece of shrink-wrap to cool after the step of applying heat to the piece of shrink-wrap causing the shrink-wrap to constrict and further comprising the step of trimming undesired portions of the piece of shrink-wrap from the item after the step of allowing the piece of shrink-wrap to cool.

30. A method in accordance with claim 26 wherein the item to be camouflaged is a firearm.
